(19) United States
(12) Patent Application Publication
(10) Pub. No.: US 2011/0295763 A1
(43) Pub. Date: Dec. 1, 2011

(54) MULTI-ATTRIBUTE SYSTEM FOR PROJECT PLANNING

(76) Inventors: Kay-Yut Chen, Santa Clara, CA (US); Jhilmil Jain, Sunnyvale, CA (US); Benjamin I. Dempster, San Francisco, CA (US)

(21) Appl. No.: 12/786,899

(22) Filed: May 25, 2010

(51) Int. Cl. G06Q 10/00; G06F 3/048

(52) U.S. Cl. 705/348; 715/810

(57) ABSTRACT

A method of planning a project includes receiving project requirements for a project to be planned and assigning scores to the project requirements based on user preferences associated with the attributes of the requirements. The method further includes generating a numerical model of the project based on the scored requirements and optimizing the score of the numerical model to generate a matching solution that matches the project requirements to vendor offerings.

Project planning can be a daunting and stressful task that, because of its complexity, is often assigned to a dedicated project planner. A project planner may be an employee of a corporation who helps to plan and manage business projects for internal clients. In other instances, a project planner has his or her own business that offers services to outside clients. As an example, it has become increasingly common to hire planners to organize large events, such as weddings and corporate parties.

The planning of a large project often requires a high degree of coordination between the various planning stages and the entities involved to ensure that a client's requirements are satisfied within schedule and budget constraints. Many factors often combine to make such coordination a challenging task. For instance, at the beginning stages of a project, a client may be overloaded with options, thus complicating the initial definition of project requirements. In addition, once project requirements are defined, the marketplace may be saturated with vendors and product offerings, which can complicate both evaluating vendors and ultimately finding a match that provides the best value between a client's requirements and available vendors. Yet further, project requirements tend to evolve over time, either due to modifications in a client's requirements or changes in available venues, vendors, services or products. A change in one requirement may affect other requirements or aspects of the project, thus presenting further complications for efficient planning.

### BRIEF DESCRIPTION OF THE DRAWINGS

Some embodiments are described with respect to the following figures:

FIG. 1 is a block diagram of an exemplary arrangement in which an embodiment of the invention is implemented.

FIG. 2 is a block diagram of an exemplary arrangement of a vendor resource manager according to an embodiment.

FIG. 3 is a flow diagram of an exemplary project planning technique according to an embodiment.

### DETAILED DESCRIPTION

A system and method are provided to facilitate project planning. Conventionally, the project planning process entails many high-touch stages where the project planner must be actively involved in gathering and capturing various pieces of information. These pieces of information range from collecting a client's project requirements to matching those requirements with suitable products or service in a manner that meets the client's needs while still meeting project constraints, such as schedule and budget. In some respect, the advent of electronic marketplaces has facilitated the project planning process by greatly increasing the ease by which a large variety of available products and services can be identified.

However, while multiple options are beneficial, the wide variety of offerings often presents difficulties in sorting through and selecting those products and services that may be best suited for a particular project. Despite the wide variety of choices, many times a particular project requirement cannot be met within the confines of the project's time and budget constraints. At other times, project requirements may change or evolve over time, due to changes either in a client's preferences and/or in the products and services available in the marketplace. In such situations, project requirements may be modified and the process for matching requirements with product or service offerings likewise may require modification. Oftentimes, requirements are interrelated, such that modification of one requirement may affect other requirements. A further complicating factor is the presence in the electronic marketplace of many vendors of unknown reputation. All in all, coordination of the project may often become a daunting and frustrating task.

Accordingly, a project planning tool is provided to facilitate the project planning process. The project planning tool provides for gathering and acquiring a client's detailed requirements and preferences for a project, matching those requirements to vendors in a manner that optimizes the value to the client, and refining the matching solution in response to new information that is made available to the planning tool, such as new or modified requirements, project constraints, vendors, product or service offerings, etc.

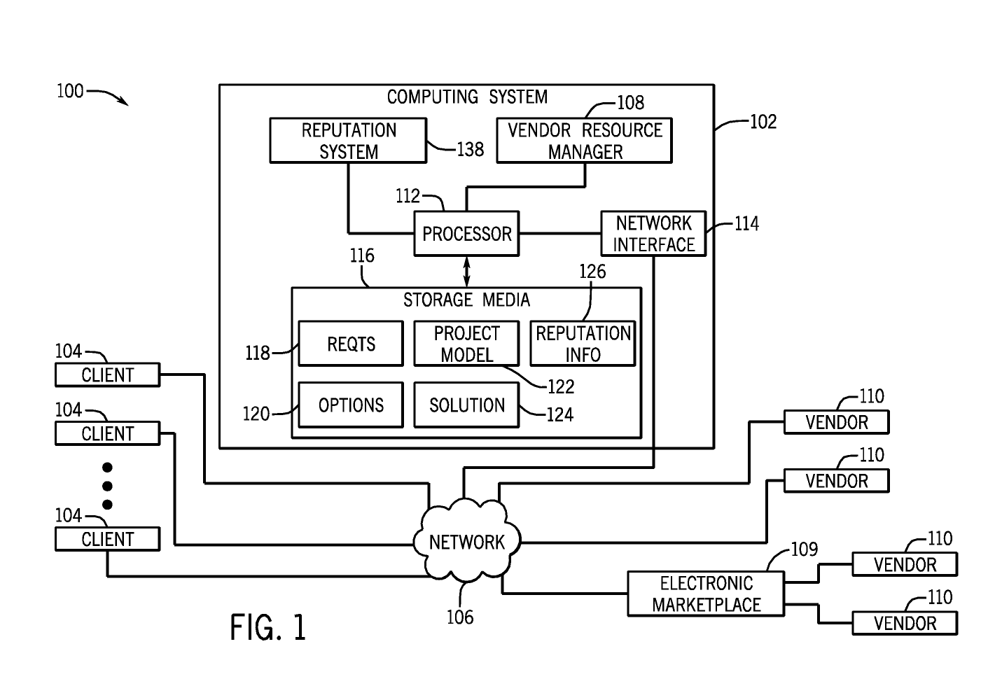

FIG. 1 illustrates an exemplary arrangement 100 that includes a server or computing system 102 in communication with one or more client computers or devices 104 via a communication network 106, such as the Internet, an intranet, local network wireless network, wide area network, combinations of the foregoing, etc. The client computers 104 may include appropriate communication applications, such as a browser, to enable the client computers 104 to communicate with the computing system 102

As shown in FIG. 1, the computing system 102 includes a vendor resource management system 108 that provides a project planning tool for interacting with client computers 104 and various vendors 110. The vendors 110 may be individual computers connected to the communication network so that the computing system 102 may communicate directly with each vendor 110. Alternatively, the vendors 110 may register with an electronic marketplace server 109, and the computing system 102 may then communicate directly with the marketplace server. In such arrangements, the marketplace server 109 may provide database services, and the vendors 110 may maintain information about their products and services in the database. For instance, each registered vendor 110 may maintain an indexed catalog of products and/or services on the marketplace database.

The vendor resource management system 108 may be executable on a processor 112 in the computer system 102. The processor 112 is connected through a network interface 114 to the communication network 106. In addition, the processor 112 is connected to storage media 116, which can be implemented with one or several disk-based storage devices and/or one or several integrated circuit (IC) or semiconductor storage devices.

The storage media 116 may be used to store project requirements 118 that are collected from the various clients 104. In addition, the storage media 116 may be used to store a collection of requirement options 120, such as videos, catalogs, photos, audio recordings, questionnaires, text descriptions, etc., that may be used to solicit project requirements 118 from client 104, as will be discussed in further detail below. Yet further, the storage media 116 may be used to store a numerical model 122 of the project that is generated based on the requirements collected from a client 104, as well as a solution 124 of a matching between project requirements 118 and vendors 110. In some embodiments, and as will be discussed in further detail below, the storage media 116 may also be used to store reputation information 126 regarding various vendors 110 that may be used to match vendors 110 to project requirements 118.

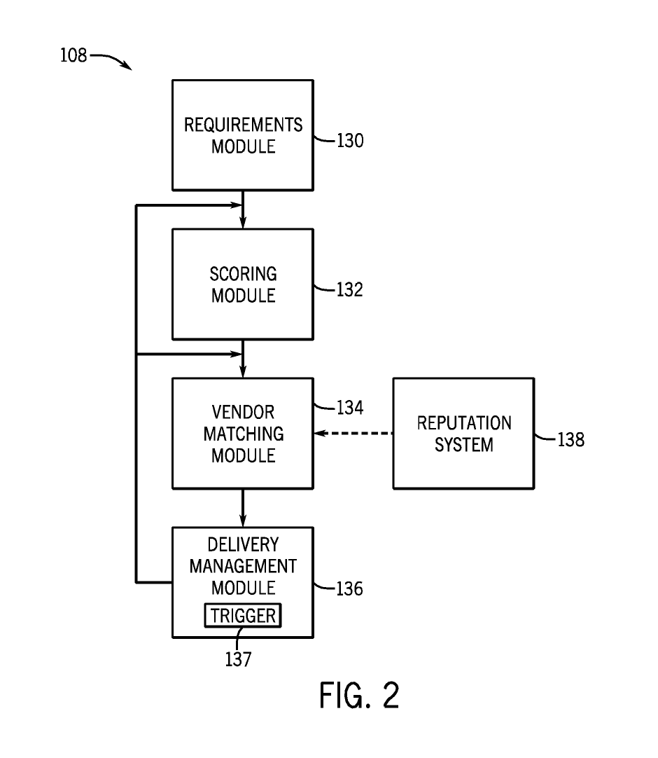

FIG. 2 shows an exemplary arrangement of the vendor resource management system 108. In this arrangement, the vendor resource management system 108 is arranged to facilitate the various phases of the project planning process. In general, the phases of a project include a discovery phase, in which information about the client's requirements and preferences are obtained; a matching phase, in which the client's requirements are matched to one or several vendors 110 in an optimal manner; and a negotiation phase, in which the ultimate delivery of the project is managed, including finalizing contracts and modifying or renegotiating contracts in the event project requirements 118 are refined

Starting first with the discovery phase of the project planning process, this phase involves the acquisition of both general and detailed project requirements. For instance, general information regarding the scope of the project may first be gathered during initial meetings or contact with a client, such as type of project (e.g., reunion, wedding, etc.), size of project, schedule, budget, number of attendees, general ideas or vision for the project, etc. This information may be input to the vendor resources management system 108 by a client computer 104 via the network 106. In some instances, the client computer 104 may be located at the client's home or place of business. In other instances, the client computer 104 may be located at the project planner's place of business, in which case communications may be established over a local communication network 106. In any event, during the discovery phase, the goal is to acquire as much information as possible from the client regarding the client's requirements and preferences.

To facilitate the acquisition of information, the vendor resource management system 108 includes a Requirements Module 130. For instance, the general project requirements may be provided as an input to the Requirements Module 130 so that the Module 130 may then solicit detailed requirements. As an example, the general requirements may assist the Module 130 in formulating or selecting a questionnaire to present to the client, as well as with selecting requirement options maintained in storage media 116 regarding various services or products in which the client may be interested or which may assist the client with formulating or articulating the client's requirements and preferences. The Module 130 may present options to the client in the form of menu items where selection of a menu item may lead to the presentation of further requirement options that are relevant to the type of project being planned.

Any suitable format may be used to present information to the client. For instance, the client may be presented with photographs, videos, audio recordings, text, etc. that may assist the client in defining the client's project requirements, including attributes of those requirements. As an example, if the client is planning a wedding and indicates that music is a requirement, various musical selections may be presented to which the client can listen. In addition, if the client indicates that floral arrangements are a requirement, photographs or pictures of floral arrangements may be presented so that the client may further define attributes of the desired floral arrangement, such as types of flowers, colors, etc. The Requirements Module 130 may use questionnaires to solicit further details or may allow the client to input comments regarding the client's requirements. The Requirements Module 130 may also accept input from the client in the form of photographs, videos, audio recordings, text, etc. and may use these submissions to discern the client's project requirements and associated attributes. The attributes acquired from the client need not have discrete values (e.g., the flower is red), but may also be expressed in terms of a continuous value or range (e.g., the number of attendees may be between 100-150).

In addition to acquiring the client's project requirements, the Requirements Module 130 determines the relative importance of the attributes associated with the requirements. In an exemplary arrangement, relative importance is determined based on rankings or ratings that are provided by the client or otherwise obtained based on information provided by the client. For instance, the client may be asked to rank attributes in accordance with a numerical ranking system.

As an example, the client has indicated a requirement for floral arrangements that include red roses. The client may indicate that the most important attribute of the floral arrangement is the color (i.e., red) and the least important attribute is the type of flower (i.e., roses).

The Requirements Module 130 may also discern preferences or rankings in other manners. For instance, the Requirements Module 130 may present a series of questions to the client, the response to which may provide an indication of the client's preferences and the relative importance of those preferences.

Once the Requirements Module 130 has acquired at least an initial set of requirements and associated attributes, a Scoring Module 132 analyzes the acquired information in order to generate a numerical model 122 of the project. For instance, the Scoring Module 132 may derive scores for the attributes based on the rankings, responses, comments and other information obtained from the client. The scores assigned to the attributes may be discrete values, a range of values, probability distributions, etc. The attributes are mapped to the scores and a numerical model 122 corresponding to the project is generated.

In an exemplary, arrangement, the Scoring Module 132 may also include an adaptive learning algorithm that uses past experiences in assigning scores to enhance the efficiency of the process of generating the numerical project model 122.

Once the project model 122 has been generated, the vendor resource management system 108 can then match the project's requirements to products and services offered by various vendors 110. Towards this end, the vendor resources management system 108 includes a Vendor Matching Module 134. Initial identification of suitable vendors 110 may be performed in a variety of manners. For instance, the vendor resources management system 108 may be in communication with an electronic marketplace service with which vendors 110 may register and advertise their products/services. The vendor resource management system 110 also may maintain a database of known vendors 110 and products and may consult that database to select suitable offerings. Yet further, the vendor resource management system 108 may generate search requests that are broadcast on the communication network 106 so that potential vendors 110 may be identified. In some implementations, the vendor resource management system 108 may direct requests for proposal to various vendors 110, and interested vendors 110 may respond with bids. The vendor matching module 108 can then match received bids to the project's requirements in a suitable manner.

More particularly, in an exemplary implementation, the goal of the Vendor Matching Module 134 is to provide scoring-based matching between requirements 118 and vendors 110 within the constraints of the client's budget and schedule. As an example, the Vendor Matching Module 134 may generate a matching solution 124 that optimizes the overall score of the numerical project model 122 within the constraints of the project's budget. For instance, optimization criteria may be defined that require the Matching Module 134 to optimize the model 122 by maximizing the model's overall score. The matching solution 124 may be fuzzy. The solution 124 may include a specific matching, a range, or a probability distribution. In one example of the Matching Module 134, the matching is implemented by stochastic optimization using known matching algorithms. In other examples, other matching algorithms and optimization techniques may be used depending on the particular types and requirements of the projects in which the matching is implemented.

It should be understood that optimization techniques and optimization criteria may vary depending on the particular project or type of project that is being planned. For instance, an optimized score of the project model 122 may be the score that satisfies all of the client's requirements within the confines of the budget. Alternatively, an optimized score may be the score that provides the best value to the client even though some attributes may not have been satisfied. Yet further, an optimized score may be a solution that offers the greatest amount of flexibility in the event that the client knows that there is a high likelihood that the project requirements will be modified in the future.

Regardless of the particular optimization technique used, once a matching solution 124 has been obtained, the solution 124 may be passed to a Delivery Management Module 136, which presents the matching solution 124 to the client for review. At this point, the client may simply accept the solution and the Delivery Management Module 136 then ensures that the proper agreements are finalized with the appropriate vendors 110, if necessary. Alternatively, the client (or the project planner) may refine the requirements and/or the attributes of those requirements, including modifying the budget, changing the number of attendees, modifying rankings associated with attributes, adding new requirements, etc. If changes are made, then the scoring and matching process may be repeated until the client is satisfied with the results and the Delivery Management Module 136 has completed negotiations and entered into agreements with the appropriate vendors

Ideally, the project planning process should be complete at this point and requirements firmly established. However, it is possible that various events may occur that may change the project's requirements. For instance, a client may become aware of new information that may prompt the client to change requirements, such as a need to provide a special menu for certain guests. As another example, a vendor or the vendor's products may become unavailable under the terms that were previously negotiated. As yet another example, a new vendor may become available that may offer more value to the project. Regardless of the reason for the change, a need to refine the deliverables may arise in response to the receipt of new information from either the client or the vendors.

Accordingly, exemplary arrangements of the Delivery Management Module 136 include an automatic renegotiation trigger 137 that is activated in response to the receipt of new information that is relevant to a planned project. In such a situation, if the new information changes the project's requirements 118, then the activation of the trigger 137 causes the Scoring Module 132 to refine the scores assigned to the requirement attributes so that an updated numerical project model 122′ may be generated. The Vendor Matching Module 134 receives the updated model 122′ and then refines the matching solution to optimize the overall score of the updated model 122′. The refined matching solution 124′ is provided to the client for review, further refinements may be made, and purchase contracts are re-negotiated if feasible and/or agreements are reached with new vendors 110. In situations in which the new information learned by the system 108 does not modify the project requirements 118 but only affects product availability, then the Vendor Matching Module 134 may simply compute a new solution 124′ based on the existing project model 122.

In some implementations of the Delivery Management Module 136, the re-negotiation trigger 137 may be activated in response to the receipt of any new information. In other implementations, the trigger 137 may be activated only if re-negotiation is feasible or if the new information will result in an improved matching solution.

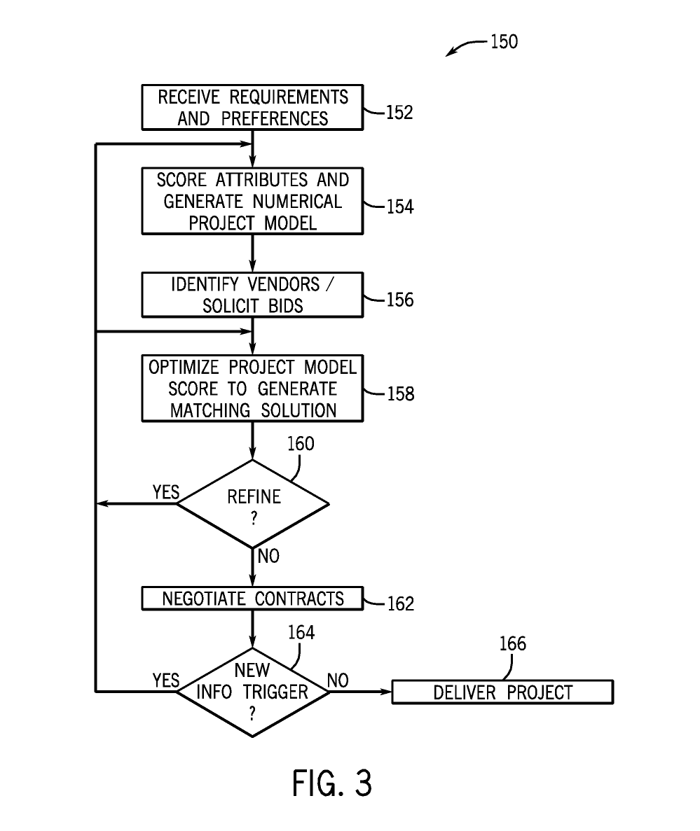

Referring now to FIG. 3, a flow chart of an exemplary process 150 for planning a project using the vendor resource management system 108 is shown. At block 152, a client's project requirements and preferences are received. The attributes of the requirements are scored based on the client's preferences and a numerical project model is generated (block 154). Potential vendors and product/service offerings are identified and bids are solicited (block 156). Bids are matched to project requirements in a manner that optimizes the score of the project model, and a matching solution is generated (block 158). At this point, the client may refine the project's requirements based, for instance, on tradeoffs between preferences and available offerings (diamond 160). If the requirement are refined, then the scores are recalculated, the model is updated, and a new matching solution is generated. Once an acceptable solution is found, then contracts may be negotiated and finalized with the appropriate vendors (block 162). If new information is later received by the vendor resource management system 108 that activates the re-negotiation trigger (diamond 164), then the scoring and/or the optimization of the project model is refined as needed. Otherwise, the project is delivered to the client (block 166).

In some implementations of the vendor resource management system 108, vendor matching may be further facilitated by a Reputation System 138 that collects and maintains information relating to the reputation of various vendors 110. The Reputation System Module may be included on the computer system 102, as shown in FIG. 1, or may be implemented in a separate computer or server. Regardless of the particular implementation, the Reputation System 138 collects reputation information 126, such as feedback or ratings about vendors 110 that have been provided by various entities, such as former or current customers of the vendors 110.

The reputation information 126 may then be provided to the Vendor Matching Module 134 so that a vendor's reputation may become a factor that affects the matching solution 124. For instance, the matching algorithm may be configured to optimize the score of the project model 122 using only vendors 110 having a reputation above a specified threshold. Yet further, the matching algorithm may provide a range of matching solutions 124 that demonstrate tradeoffs between value and reputation.

In yet other implementations, vendor reputation can be a requirement that is input by the client. For instance, the client may specify that only vendors having a specified reputation score may be considered for the matching.

The various modules described above for performing the project planning technique 150 depicted in FIG. 3 have been given as examples only. It should be understood that other arrangements of the vendor resource management system 108 are contemplated. For instance, the modules may be implemented in other manners such that the processes described above may be carried out by more or fewer modules. Further, it should be understood that the technique 150 may include more or fewer steps than those shown in FIG. 3, and that the order of some of the steps may be altered.

Instructions of software described above (including the planning process 150 of FIG. 3 and the processes carried out by modules 130, 132, 134 and 136 of FIG. 2) are loaded for execution on a processor, such as the processor 112 of FIG. 1. A processor can include a microprocessor, microcontroller, processor module or subsystem, programmable integrated circuit, programmable gate array, or another control or computing device. As used here, a “processor” can refer to a single component or to plural components (e.g., one CPU or multiple CPUs).

Data and instructions are stored in respective storage devices, which are implemented as one or more computer-readable or machine-readable storage media. The storage media, such as media 116 in FIG. 1, include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of planning a project, comprising
receiving a plurality of project requirements associated with a project;
assigning, using a processor-based device, scores to the project requirements to generate a numerical project model; and
matching, using a processor-based device, the project requirements to vendor offerings based on an optimization of the numerical project model.

2. The method as recited in claim 1, further comprising determining an overall project score associated with the numerical project model.

3. The method as recited in claim 2, wherein the optimization of the numerical project model optimizes the overall project score.

4. The method as recited in claim 3, wherein the optimization of the numerical project model maximizes the overall project score.

5. The method as recited in claim 1, wherein receiving the project requirements comprises:
acquiring, from a user, attributes associated with the requirements; and
ranking the attributes based on preferences of the user.

6. The method as recited in claim 5, wherein assigning scores comprises mapping attributes to scores based on the ranking.

7. The method as recited in claim 6, wherein the assigned scores are probabilistic.

8. The method as recited in claim 1, further comprising obtaining reputation information associated with vendor offerings, and wherein matching the project requirements to vendor offering is further based on the reputation information.

9. The method as recited in claim 1, further comprising:
receiving a new project requirement after completing the matching; and
automatically updating the matching in response to receipt of the new project requirement.

10. The method as recited in claim 9, further comprising automatically updating the numerical project model in response to receipt of the new project requirement

11. The method as recited in claim 1, wherein receiving project requirements comprises presenting to a user a plurality of requirement options for selection.

12. The method as recited in claim 11, wherein the requirement options may be presented to the user in at least one of a video format and an audio format.

13. The method as recited in claim 12, wherein receiving project requirement comprises receiving from the user a project requirement in at least one of a video format and an audio format.

14. A computer system, comprising:
storage media to store project requirements collected regarding a project to be planned for a client; and
at least one processor to:
assign scores to the project requirements;
generate a numerical model corresponding to the project based on the assigned scores;
match project requirements to vendor bids based on an optimization of the numerical model; and
generate a matching solution to present to the client.

15. The computer system as recited in claim 14, wherein attributes of the project requirements are ranked in accordance with client preferences, and wherein the at least one processor is further configured to assign scores to the attributes based on the ranking.

16. The computer system as recited in claim 15, wherein the at least one processor is further configured to calculate a project score corresponding to the numerical model.

17. The computer system as recited in claim 16, wherein the optimization of the numerical model is based on optimizing the project score.

18. The computer system as recited in claim 17, wherein the project score is probabilistic.

19. An article comprising at least one computer-readable storage medium containing instructions that upon execution cause a computer to:
collect requirements associated with a project to be planned for a user;
collect attributes associated with the requirements;
determine rankings of the attributes based on preferences of the user;
assign scores to the attributes;
generate a numerical model corresponding to the project based on the assigned scores; and
generate a matching solution that matches the project requirements to vendor offerings based on an optimization of the numerical model.

20. The article as recited in claim 19, wherein the instructions upon execution further cause a computer to compute a project score associated with the numerical model, and wherein the optimization of the numerical model optimizes the project score.
